(19) United States
(12) Patent Application Publication
(10) Pub. No.: US 2012/0159731 A1
(43) Pub. Date: Jun. 28, 2012

(54) BRUSH FILAMENTS PREPARED FROM A POLYTRIMETHYLENE TEREPHTHALATE COMPOSITION AND BRUSHES COMPRISING THE SAME

(75) Inventors: Xianqiao Liu, Shanghai (CN); Yong Ni, Shanghai (CN)

(73) Assignee: E. I. DU PONT DE NEMOURS AND COMPANY, Wilmington, DE (US)

(21) Appl. No.: 13/313,082

(22) Filed: Dec. 7, 2011

(30) Foreign Application Priority Data
Dec. 22, 2010 (CN) 201010613359.8

(51) Int. Cl. A46B 9/04; C08L 67/03; A46D 1/00

(52) U.S. Cl. 15/167.1; 15/207.2; 525/437

(57) ABSTRACT

Disclosed herein is a monofilament bristle made of modified polytrimethylene terephthalate composition having s a flexural modulus of 2500 MPa or lower, measured according to ISO178:2001, a tensile modulus of 2600 MPa or lower, and an elongation at break % of about 20% or lower, measured respectively according to ISO527-2:1993, wherein the composition comprises: (a) 65-95 wt. % of at least a polytrimethylene terephthalate, and (b) 5-35 wt. % of at least a copolyether-ester having a Shore Hardness of 55 or higher measured according to ISO868. The invention also discloses brushes comprising the monofilament bristle.

### CROSS-REFERENCE TO RELATED APPLICATIONS

The present application claims priority to Chinese patent application CN 201010613359.8 filed on Dec. 22, 2010.

### FIELD OF THE INVENTION

The present invention relates to a monofilament bristle, and more specifically to a monofilament bristle made of modified polytrimethylene terephthalate composition. The invention also relates to brushes comprising the monofilament bristle.

### FIELD OF THE INVENTION

In the fields of tooth brushes, paint brushes, cosmetic brushes and so on, the monofilament bristles are usually made of chemically synthetic materials such as polyamides or polybutylene terephthalate (PBT), etc. Due to the desired functional features of a toothbrush, there are some special requirements in choosing monofilament bristle materials. For example, polyamide 6,12 has been used in toothbrushes because it is soft when contacted in use, will not harm the teeth, and has good flexural recoverability. However, polyamide is highly hygroscopic; when it absorbs water, its physical properties and flexural recoverability decrease, and its inherent size changes significantly. Therefore, if the toothbrush is continually used for some time, the polyamide monofilament bristles begin to fray/separate from each other, thereby decreasing its durability. Furthermore, using polyamide costs more. In addition, due to PBT's own high hardness, poor tenacity, high brittleness and high rigidity, it cannot be directly used for making toothbrushes. In the industry, the tips of the monofilament bristle made by polybutylene terephthalate are usually sharpened with a chemical flux etching technique, and it is softened before it is used for the toothbrushes. This method undoubtedly increases cost and causes problems such as environment pollution by chemical etching solutions.

In recent years, polytrimethylene terephthalate (PTT) has been introduced as a type of high performance polymer in the field of polymeric synthetic material. It is a type of thermoplastic polyester that has excellent performance, outstanding chemical resistance, elasticity, better dyeability and color fastness, as well as having advantages such as good stain resistance, resistance to ultra light, resistance to nitrogen oxides, resistance to ozone, and antistatic, etc. In addition, because 1,3-propylene glycol, which is one of the starting materials used in the preparation of polytrimethylene terephthalate, can be obtained via biochemical process, its application further gains extensive attention and investigation.

For example, polytrimethylene terephthalate polymer has been used in textile industry. U.S. Pat. No. 6,462,145 discloses a blend comprising polytrimethylene terephthalate polymer and a low hardness elastomeric polyester (such as Hytrel®4056 copolyether-ester resin which has a Shore Hardness of 40), and a fiber made by the blend. The industrial fabrics made by the fiber have improved dimensional stability and mechanical properties.

The use of polytrimethylene terephthalate polymer in the industry of monofilament bristle, especially in the industry of toothbrush bristle, has been disclosed as well, for example, in U.S. Pat. No. 6,053,734. Specifically, U.S. Pat. No. 6,053,734 discloses a monofilament bristle made of polytrimethylene terephthalate polymer and a monofilament bristle with a core-sheath structure. The monofilament bristle with the core-sheath structure comprises a core formed by a polymer having high flexural elastic modulus, such as polyethylene terephthalate (PET), and a sheath formed by polytrimethylene terephthalate.

In addition, a Japanese patent application JP 2007-000519 also discloses a bristle and a toothbrush made by the bristle. The bristle also has a core-sheath structure and comprises a core and two or more resin layers coating the core in the form of a concentric circle, wherein the core is made of polytrimethylene terephthalate, and the outer resin layer is made of polyester-based resin (such as Hytrel® copolyether-ester resin) other than polytrimethylene terephthalate, and an intermediate layer interposed between the core and the outer resin layer is made of the blend of polytrimethylene terephthalate and above polyester-based resin other than polytrimethylene terephthalate. The function of the intermediate resin layer is to provide the adhesion between the core and the outer layer of the bristle.

Although in prior art polytrimethylene terephthalate has been used in making the monofilament bristle, the inventors of the present application have discovered that in terms of its applications in toothbrushes, paint brushes, cosmetic brushes or industrial brushes, the hardness of polytrimethylene terephthalate is still high, and because of its poor tenacity and high brittleness, it needs to be further modified in order to provide modified products with simple process, low cost and the ability to concurrently meet the demand of monofilament bristle with different physical properties in the production, resulting in polytrimethylene terephthalate compositions having characteristics such as softness, low elongation at break % and high flexural recoverability at the same time.

### SUMMARY OF THE INVENTION

Disclosed herein is a monofilament bristle made of modified polytrimethylene terephthalate composition, wherein, based on the total weight of the modified polytrimethylene terephthalate composition, the modified polytrimethylene terephthalate composition comprises:
(a) 65-95 wt. % of at least a polytrimethylene terephthalate, and
(b) 5-35 wt. % of at least a copolyether-ester having a Shore Hardness of 55 or higher measured according to ISO868,
   and the modified polytrimethylene terephthalate composition has a flexural modulus of 2500 MPa or lower measured according to ISO178:2001, a tensile modulus of 2600 MPa or lower, and an elongation at break % of 20% or lower, measured respectively according to ISO527-2:1993.

Also disclosed is a brush comprising the monofilament described herein immediately above.

### BRIEF DESCRIPTION OF THE FIGURES

In the following, the invention is further illustrated in detail through figures, wherein:

FIG. 1A-1C respectively shows the photographs of the pellets of each composition obtained from Examples 1-3; and

FIG. 2A-2D respectively shows the photographs of the melt extrudates of each composition obtained from Comparative Examples 7-10.

### DETAILED DESCRIPTION OF THE INVENTION

Unless otherwise stated, all publications, patent applications, patents and other references mentioned in this text are incorporated entirely into this text in the way of citation, as if presented in full in this text.

Unless otherwise defined, all technical and scientific terms used in this text have the same meaning as those used by persons of ordinary skill in the art. In case of a conflict, the definitions in this text shall govern.

Unless otherwise stated, all percents, parts, ratios, etc. are based on weight.

Used in the text, the term “made of” has the same meaning as “encompass”. The terms “comprise”, “include”, “contain”, “have”, or any other their variants are used in the text, intending to cover non-exclusive inclusions. For example, compositions, techniques, methods, manufactures, or apparatus comprising a series of elements is not necessarily limited to those recited elements, and may include unspecified elements or other inherent elements within these compositions, techniques, methods, manufactures, or apparatus.

When using scope, preferred scope, or preferred numerical upper limit and preferred numerical lower limit as forms to express certain quantity, concentration, other value, or parameter, it should be understood as it equivalently specifically discloses any scope constituted by any pair of scope upper limit or preferred value and scope lower limit or preferred value, without concerning if the scope is specifically disclosed or not. Unless otherwise stated, the value scopes listed in the text intend to include scope endpoints and any integers and fractions within the scopes.

It should be pointed out that, in the present invention, when any value range provides specific values of the upper and lower endpoints, the scope includes any value within the endpoints and the equal or almost equal values of the endpoints.

The present invention primarily relates to a monofilament bristle made of modified polytrimethylene terephthalate composition, wherein, based on the total weight of the modified polytrimethylene terephthalate composition, the modified polytrimethylene terephthalate composition comprises:
(a) About 65-95 wt. % of at least a polytrimethylene terephthalate (PTT), and
(b) About 5-35 wt. % of at least a copolyether-ester, the at least a copolyether-ester has a Shore Hardness of about 55 or higher measured according to ISO868,
   and the modified polytrimethylene terephthalate composition has a flexural modulus of about 2500 MPa or lower measured according to ISO178:2001, a tensile modulus of about 2600 MPa or lower, and an elongation at break % of about 20% or lower, measured respectively according to ISO527-2:1993.

In one aspect, the present invention provides a monofilament bristle made of modified polytrimethylene terephthalate composition, wherein, based on the total weight of the modified polytrimethylene terephthalate composition, the polytrimethylene terephthalate composition comprises: (a) 65-95 wt. % of at least a polytrimethylene terephthalate, and (b) 5-35 wt. % of at least a copolyether-ester which has a Shore Hardness of 55 or higher measured according to ISO868. Furthermore, the modified polytrimethylene terephthalate composition has a flexural modulus of 2500 MPa or lower measured according to ISO178:2001 a tensile modulus of 2600 MPa or a lower, and an elongation at break % of 20% or lower, measured respectively according to ISO527-2:1993.

In an embodiment of the monofilament bristle, the modified polytrimethylene terephthalate composition is a single phase composition formed by at least a polytrimethylene terephthalate and at least a copolyether-ester.

In another embodiment of the monofilament bristle, based on the total weight of the modified polytrimethylene terephthalate composition, the at least a polytrimethylene terephthalate and at least a copolyether-ester are present in an amount of 70-90 wt. % and 10-30 wt. % respectively, or preferably 75-85 wt. % and 15-25 wt. % respectively.

In another embodiment of the monofilament bristle, the modified polytrimethylene terephthalate composition has a flexural modulus of 1800-2500 MPa, a tensile modulus of 1800-2600 MPa, and an elongation at break % of 5-15%.

In another embodiment of the monofilament bristle, the modified polytrimethylene terephthalate composition has a flexural modulus of 2100-2300 MPa, a tensile modulus of 2200-2300 MPa, and an elongation at break % of 8-15%.

In an embodiment of the monofilament bristle, the at least a copolyether-ester has a Shore Hardness of 55-82, or preferably 60-70, measured according to ISO868.

In another embodiment of the monofilament bristle, the at least a polytrimethylene terephthalate has an intrinsic viscosity of 0.8-1.7 dl/g, or preferably 0.9-1.4 dl/g.

In another embodiment of the monofilament bristle, the copolyether-ester comprises a plurality of repeating long-chain ester units and repeating short chain ester units linked head to tail through ester bond, the long chain ester unit is represented by Formula (I):

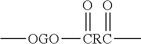

and the short chain ester unit is represented by Formula (II):

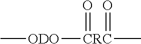

wherein:

G is a residual divalent group by the removal of the ending hydroxyl group from poly (methylene ether) diol having a number average molecular weight of 400-6000;

R is a residual divalent group by the removal of the carboxylic group from dicarboxylic acids having a number average molecular weight of 300 or less;

D is a residual divalent group by the removal of the hydroxyl group from diol having a number average molecular weight of 250 or less;

And wherein:

The copolyether-ester comprises 1-60 wt. % of the repeating long chain ester units and 40-99 wt. % of the repeating short chain units.

In another embodiment of the monofilament bristle, the copolyether-ester comprises 10-50 wt. % of the repeating long chain ester units and 50-90 wt. % of the repeating short chain units.

In another aspect, the present invention provides a brush comprising the above monofilament bristle. The brush is selected from toothbrushes, paint brushes, cosmetic brushes and industrial brushes; or preferably toothbrushes.

The polytrimethylene terephthalate used in the invention can be polyester obtained by the condensation of 1,3-propylene glycol and terephthalic acid (or terephthalate). The 1,3-propylene glycol used in the preparation of polytrimethylene terephthalate can be obtained preferably via biochemical processes from renewable resources (the 1,3-propylene obtained via a biochemical process). A person skilled in the art could use a polytrimethylene terephthalate having a single intrinsic viscosity or concurrently use several polytrimethylene terephthalates with different intrinsic viscosities. Polytrimethylene terephthalate used preferably in the invention is selected from polytrimethylene terephthalates having an intrinsic viscosity of about 0.8-1.7 dl/g, and more preferably, the at least a polytrimethylene terephthalate is selected from polytrimethylene terephthalates having an intrinsic viscosity of about 0.9-1.4 dl/g.

A preferred polytrimethylene terephthalate is the polytrimethylene terephthalate produced by E.I. DuPont de Nemours and Company, USA (hereinafter referred to as DuPont) and marketed as Sorona® polytrimethylene terephthalate resin and having an intrinsic viscosity of 0.96 dl/g. The starting material 1,3-propylene used for making Sorona® polytrimethylene terephthalate is obtained via fermentation of corn sugar. Therefore, 37% of the starting materials for the polymer may come from natural renewable resources rather than traditional petrochemical feedstock, thus reducing dependence on mineral and fossil resources.

The copolyether-ester refers to a copolymer wherein its polymeric long chain contains polyester block and polyether block.

Copolyether-ester suitable for the present invention may comprise a plurality of repeating long-chain ester units and repeating short chain ester units linked head to tail through ester bond. The long chain ester unit is represented by Formula (I):

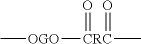

And the short chain ester unit is represented by Formula (II):

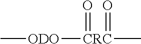

Wherein:

G is a residual divalent group by the removal of the ending hydroxyl group from poly (methylene ether) diol having a number average molecular weight of about 400-6000;

R is a residual divalent group by the removal of the carboxylic group from dicarboxylic acids having a number average molecular weight of about 300 or less;

D is a residual divalent group by the removal of the hydroxyl group from diol having a number average molecular weight of about 250 or less;

During the preparation of the copolyether-ester, a person skilled in the art can adjust the Shore Hardness by adjusting the amount of the repeating long-chain ester units and repeating short chain ester units present in the copolyether-ester. In the present invention, the copolyether-ester has a Shore Hardness of about 55 or higher, preferably about 55-82, more preferably about 60-70, measured according to ISO868. Correspondingly, in the used copolyether-ester, the repeating long-chain ester units are present in an amount of about 1-60 wt. % or preferably about 10-50 wt. %; the repeating short chain ester units are present in an amount of about 40-99 wt. % or preferably about 50-90 wt. %.

The “long-chain ester unit” described herein refers to the product obtained through the reaction of long chain diol with dicarboxylic acid. The suitable long chain diols are poly (alkylene ether) diols having the hydroxyl-terminated and number average molecular weight of about 400-6000 or about 600-3000, including but not limited to poly (tetramethylene ether) diol, poly (trimethylene ether) diol, polypropylene glycol, polyethylene oxide diols, copolymers of above poly (alkylene ether) diols and block copolymers of such as polyols (propylene oxide) with ethylene oxide-terminated. The long chain diols can be mixtures of two or more mentioned diols.

The “short-chain ester unit” described herein refers to the product obtained through the reaction of low molecular weight diol or its ester derivative with dicarboxylic acid. The suitable low molecular weight diols have a number average molecular weight equal to or smaller than about 250 (or about 10-250, or about 20-150, or about 50-100), including but not limited to aliphatic dihydroxy compounds, alicyclic dihydroxy compounds, and aromatic dihydroxy compounds (including diphenol). In an embodiment, the low molecular weight diols used are dihydroxy compounds containing about 2-15 carbon atoms, for example, ethylene glycol, propylene glycol, iso-butandiol, 1,4-butandiol, 1,4-pentandiol, 2,2-dimethyl propylene glycol, 1,6-hexandiol, 1,10-docandiol, dihydroxy cyclohexane, cyclohexane dimethanol, resorcinol, hydroquinone, 1,5-dihydroxynaphthalene, etc. In another embodiment, the low molecular weight diols used are dihydroxy compounds containing about 2-8 carbon atoms. In another embodiment, the low molecular weight diol used is 1,4-butandiol. The suitable diphenols include bis (p-hydroxy) phenyl, bis(p-hydroxyphenyl)methane, and bis (p-hydroxyphenyl) propane.

The ester derivatives of the low molecular weight diols suitable herein refer to the ester derivatives derived from the above low molecular weight diols, for example, ester derivative of ethylene glycol (such as ethylene oxide or glycol carbonate) or ester derivatives of resorcinol (such as oxalic acid ester of resorcinol). Herein, the restriction of the number average molecular weight applies only to the low molecular weight diols. Therefore, as long as the number average molecular weight of the low molecular weight diol is equal to or less than about 250, the ester derivative having a number average molecular weight larger than about 250 is suitable as well.

The dicarboxylic acids reacting with the above long chain diols or low molecular weight diols are low molecular weight (i.e. number average molecular weight equal to or less than about 300, or about 10-300, or about 30-200, or about 50-100) aliphatic, alicyclic, or aromatic dicarboxylic acids.

The “aliphatic dicarboxylic acids” described herein refer to carboxylic acids having two carboxyl groups each connected to saturated carbon atoms. If the carbon atoms connected to the carboxyl group are saturated and on the aliphatic carbon ring, then the carboxylic acid is “alicyclic acid”. The “aromatic dicarboxylic acids” described herein refer to carboxylic acids having two carboxyl groups each connected to aromatic ring carbon atoms. The two carboxyl groups in the aromatic dicarboxylic acids are not necessarily connected to the same aromatic ring. When the aromatic dicarboxylic acids contain a plurality of aromatic rings, the plurality of aromatic rings may be connected through aliphatic or aromatic divalent groups or a divalent group such as that of —O— or —SO₂—.

The suitable aliphatic or alicyclic dicarboxylic acids include but are not limited to decandioic acid, 1,3 cyclohexandioic acid, 1,4-cyclohexandioic acid, hexandioic acid, pentendioic acid, 4-cyclohexane-1,2-dicarboxylic acid, 2-ethyl-octandioic acid, cyclopentandioic acid, decahydro-1,5-naphthalend dicarboxylic acid, 4,4′-bicyclohexyl dicarboxylic acid, decahydro-2,6 naphthalene dicarboxylic acid, 4,4′-methylene bis(cyclohexyl) carboxylic acid and 3,4-furnandicarboxylic acid. In an embodiment, the dicarboxylic acid is selected from cyclohexandioic acid, hexandioic acid and combinations thereof.

Suitable aromatic dicarboxylic acids include 1,2-benzenedicarboxylic acid, 1,4-benzenedicarboxylic acid, 1,3-benzenedicarboxylic acid, diphenyl dicarboxylic acid, dicarboxylic acids with two benzene nucleus (such as diphenylmethane-4,4′-dicarboxylic acid, p-hydroxyl-1,5-naphthalene dicarboxylic acid, 2,6-naphthalene dicarboxylic acid, 2,7-naphthalene dicarboxylic acid and 4,4′-sulfonyl dibenzoate) and the C₁-C₁₂ alkyl or cyclic substituted derivatives of the above mentioned aromatic dicarboxylic acid (for example, halogenated, alkoxy or aromatic substituted derivatives). The suitable aromatic dicarboxylic acid can be, for example, hydroxy acids of p-(β-hydroxy ethoxy) benzoic acid.

In an embodiment of the invention, the dicarboxylic acid used to form copolyether ester is selected from aromatic dicarboxylic acid. In another embodiment of the invention, the dicarboxylic acid is selected from aromatic dicarboxylic acid having about 8-16 carbon atoms. In another embodiment of the invention, the dicarboxylic acid can be 1,4-benzenedicarboxylic acid alone or the mixtures of 1,4-benzenedicarboxylic acid and 1,2-benzenedicarboxylic acid, and/or 1,3-benzenedicarboxylic acid.

In addition, suitable dicarboxylic acids also include functional equivalents of the dicarboxylic acids. In the process of forming copolyether ester polymer, functional equivalents of the dicarboxylic acids can react with the above long chain diols or low molecular weight diols in essentially the same way as dicarboxylic acids. The suitable functional equivalents of the dicarboxylic acids include esters of dicarboxylic acids and ester derivatives, such as acyl halides and acid anhydrides. Herein, the restriction of number average molecular weight applies only to the corresponding dicarboxylic acids, rather than their functional equivalents (such as esters of dicarboxylic acids or ester derivatives). Therefore, as long as the number average molecular weight of the corresponding dicarboxylic acid is equal to or less than about 300, the functional equivalents having a number average molecular weight of higher than about 300 are suitable as well. In addition, the suitable dicarboxylic acids may also contain any substituted groups or combinations thereof which do not essentially affect the formation of the above copolyether ester polymer and their use in the composition.

The long chain diols used in the formation of copolyether ester components can be mixtures of two or more long chain diols. Similarly, the low molecular weight diols and dicarboxylic acids used in the formation of copolyether ester components can be mixtures of two or more low molecular weight diols and mixtures of two or more dicarboxylic acids, respectively. In a preferred embodiment, at least about 70 mole % group represented by R in the above Formula (I) and (II) is 1,4-phenylene, at least about 70 mole % group represented by D in the above Formula (II) is 1,4-butylidene. If two or more dicarboxylic acids are used in the synthesis of the copolyether ester, the use of the mixtures of 1,4-benzenedicarboxylic acid and 1,3-benzenedicarboxylic acid is preferred. If two or more low molecular diols are used, then the use of the mixture of 1,4-butandiols and 1,6-hexandiols is preferred.

Copolyether ester can be a blend of two or more copolyether esters. It is not required that each of the copolyether esters used in the blend be within the limited weight percent range disclosed regarding the long chain ester unit and short chain ester unit described above. However, based on the weighted average, a blend of two or more copolyether esters must be within the limited scope regarding copolyether ester. For example, in a blend comprising equivalent amount of two copolyether esters, wherein one copolyether ester may contain about 30 wt. % of the short chain ester unit, and the other copolyether ester may contain about 80 wt. % of the short chain ester unit. Therefore the obtained weighted average of the short chain ester unit in the blend is about 55 wt. %.

In an embodiment, at least a copolyether ester component is obtained through the copolymerization of dicarboxylic acid selected from the ester of 1,4-benzenedicarboxylic acid, the ester of 1,3-benzenedicarboxylic acid and combinations thereof, with a long chain diols, one of which is a low molecular diols 1,4-butandiols, and the other of which is poly (tetramethylene ether) diol or poly (propylene oxide) diol terminated with ethylene oxide. In another embodiment, the polyether ester is obtained from copolymerization of ester of 1,4-benzenedicarboxylic acid (such as dimethyl terephthalate) with 1,4-butandiols and poly(tetramethylene ether) diol.

Copolyether ester suitable for the composition disclosed herein can be prepared by the methods known to a person skilled in the art, for example, by the conventional ester exchange reaction.

In an embodiment, the preparation method comprises heating the a dicarboxylic ester (such as dimethyl phthalate), a poly (alkylene ether) diol and molar excessive low molecular weight diols (1,4-butandiol) in the presence of a catalyst, then distilling to remove methanol formed through ester exchange reaction, continuing the heating process until no more methanol is distilled out. Depending on temperature, and selection of catalyst, and the amount of low molecular weight diols, polymerization reaction can be completed within a few minutes to several hours, to obtain a low molecular weight prepolymer. This kind of prepolymer may be prepared through many other esterification and ester exchange methods, for example, long chain diols may react with short chain ester homopolymer or copolymer in the presence of catalysts until randomization occurs. The above short chain ester homopolymer or copolymer can be prepared via ester exchange between dimethyl ester (such as dimethyl phthalate) and the above low molecular weight diols (such as 1,4-butandiol), or ester exchange between free acid (such as 1,4-benzenedicarboxylic acid) and diol acetate (such as 1,4-butane dioic acid diethyl ester). Or, the above short chain ester copolymer can also be prepared via direct esterification of suitable acids (such as terephthalic), acid anhydrides (such as phthalic anhydride) or acyl halides (such as terephthaloyl chloride) with diols (such as 1,4-butandiol). Or, the above short chain ester-ester copolymer may be prepared via other effective methods such as the reaction of acids with cyclic ethers or carbonates.

The molecular weights of the prepolymers obtained from the above methods may be increased through distilling excessive amounts of low molecular weight diols. This method is called “condensation”. During the process of condensation, further ester exchange may occur, thereby increasing its molecular weight and randomizing the arrangement of the copolyether ester unit. In order to obtain optimal results, this condensation occurred at the pressure of less than about 1 mm, at a temperature of about 240° C.-260° C., and in the presence of antioxidants (such as 1,6-bis[(3,5-di-tert-butyl-4-hydroxyphenyl)amino phenyl acetone]hexane or 1,3,5-trimethyl 2,4,6-tris[3,5-di-tert-butyl-4-hydroxybenzyl]benzene), and the condensation process usually lasts less than about two hours. In order to avoid irreversible thermal degradation caused by long retention time at high temperatures, the use of catalysts for ester exchange is preferred. Various catalysts are suitable for the invention, including but not limited to organic titanate (such as tetrabutyl titanate alone or its combination with magnesium acetate or calcium acetate), complex titanates (such as complex titanates derived from alkali metal or alkaline earth metal alkoxides), inorganic titanates (such as lanthanum titanate), mixture of calcium acetate/antimony trioxide, lithium and magnesium alkoxides, stannous catalyst, and combinations of two or more above catalysts thereof.

The copolyether ester are also commercially available, for example, copolyether ester elastomer from DuPont, USA marketed as Hytrel® thermoplastic polyester elastomer.

In the present invention, based on the total weight of the modified polytrimethylene terephthalate composition, the polytrimethylene terephthalate is present in an amount of about 65-95 wt. %, preferably about 70-90 wt. %, more preferably about 75-85 wt. %. The copolyether-ester is present in an amount of about 5-35 wt. %, preferably about 10-30 wt. %, more preferably about 15-25 wt. %.

In the present invention, the modified polytrimethylene terephthalate composition has a flexural modulus of about 2500 MPa or lower, or preferably about 1800-2500, or more preferably about 2100-2300, measured according to ISO178:2001; and a tensile modulus of about 2600 MPa or lower, or preferably about 1800-2600, or more preferably about 2200-2300, and an elongation at break % of about 20% or lower, or preferably about 5-15% or more preferably about 8-15%, measured respectively according to ISO527-2:1993.

In order to lower the flexural modulus and tensile modulus of a material, one would consider adding another soft material. One skilled in the art would predict that the elongation at break % would increase accordingly when soft materials are added to the lower flexural modulus and the tensile modulus.

In the present invention it has been demonstration, through experiments, that when polybutylene terephthalate (PBT) is added to copolyether ester, compared to polybutylene terephthalate, the flexural modulus and tensile modulus of the obtained composition decrease; and its elongation at break % increases significantly. It is been discovered, surprisingly, that when polytrimethylene terephthalate is added to copolyether ester, the flexural modulus and tensile modulus of the obtained composition decrease respectively compared to polytrimethene terephthalate, but the elongation at break % remain basically the same or slightly decrease.

On the other hand, during the process of adding soft materials into polyester material, the problem of incompatibility between two materials usually occurs. When two materials have poor compatibility, they may stay respectively in two phases, which could worsen the processability and eventually decrease the formability and durability of the product, or indirectly affect the further extrusion spinning

The modified polytrimethylene terephthalate composition of the monofilament bristle of the present invention comprising polytrimethylene terephthalate and copolyether ester with a Shore Hardness of about 55 or higher can form homogeneous single-phase or single phase, and possesses excellent formation processability.

In the present invention, the term “single-phase” or “single phase” refers to two substances integrating to each other without obvious phase interface between them under the microscope, or the section and appearance of the product are homogeneous without obvious delamination and phase interface, and unable to be separated by ordinary techniques such as by the means of mechanical separation.

The modified polytrimethylene terephthalate composition of the present invention can form homogeneous single phase due to selected copolyether Shore durometer hardness of about 55 or higher.

As demonstrated in the Examples, when copolyether ester Hytrel®4056 (having a Shore Hardness of 40, and produced by DuPont USA) and polytrimethylene terephthalate are melt-blended and extruded, the extrudate line breaks, and the incompatibility is obvious. When copolyether ester Hytrel®6356 (having a Shore Hardness of 63, and produced by DuPont USA) and polytrimethylene terephthalate are melt-blended and extruded, the obtained composition has good processability, and single phase regular pellets can be obtained.

The composition may optionally comprise a small amount of additives commonly used and well-known in the polymer field. The examples of the additives include, without limitation, antioxidant, heat stabilizer, UV stabilizer, colorant including dye and pigment, lubricant, anti-hydrolysis agent and flame retardant. These additives are usually present in the composition in an amount of about 0.01-15 wt. %, preferably about 0.01-10 wt. %, as long as they don't reduce and damage the basic and novel characteristics of the compositions, and don't affect the properties of the composition adversely.

There is no special restriction on the preparation process of the monofilament bristle of the present invention. It can be any publicly known polymer blending method in the art, including solution extrusion spinning process and melt extrusion spinning process, preferably the melt extrusion spinning process. For example, the monofilament bristle of the present invention can be prepared through the following process: after polytrimethene terephthalate, copolyether ester, and other optional existing additives are melt-extruded via an extruder, monofilament bristles can be obtained via stretching and shaping, wherein the extruding temperature may be set at about 235-290° C., preferably about 245-265° C., extruding speed at about 200-400 rpm, and the throughput at about 15-30 kg/hr.

The monofilament of the present invention may be used in various areas according to different usage. In a preferred embodiment, the monofilament bristle refers to monofilament bristle used in toothbrushes, paint brushes, cosmetic brushes or industrial brushes.

The invention also provides a brush that comprises the monofilament bristle of the present invention. Preferably, the brushes of the present invention are toothbrushes, paint brushes or cosmetic brushes. If necessary, toothbrushes, paint brushes, cosmetic brushes or industrial brushes may comprise at least one bunch of the monofilament bristle of the present invention, wherein one bunch of monofilament bristle comprises at least one monofilament bristle of the present invention, more preferably several bunches of the invention monofilament bristle.

In toothbrushes, paint brushes, or cosmetic brushes, the monofilament bristle of the present invention can be used alone or used in combination with other monofilament bristle comprising other components or fiber, wherein the other components can be for example, polyamide, polyethylene terephthalate or polybutylene terephthalate, etc.

In another preferred embodiment, the brushes of the present invention are toothbrushes, which comprise at least one bunch of monofilament bristles of the present invention, preferably several bunches of the monofilament bristles of the present invention. More preferably, the monofilament bristles used in the toothbrushes consist essentially of or consist entirely of the monofilament bristles of the present invention.

### EXAMPLES

The present invention is further illustrated with the following examples; but the scope of the invention is not limited by these particular examples contained herein. Unless otherwise stated, all ratios and percents are based on weight.

The materials used in the examples are:

PTT: a polytrimethylene terephthalate resin, produced by DuPont USA and marketed as Sorona®, and having an intrinsic viscosity of 0.96 dl/g;

PBT: a polybutylene terephthalate resin, produced by DuPont USA and marketed as Crastin®6130;

Copolyether ester-1: a copolyether ester resin, produced by DuPont USA and marketed as Hytrel®6356, and having a Shore Hardness of 63, measured according to ISO868;

Copolyether ester-2: a copolyether ester resin, produced by DuPont USA and marketed as Hytrel®4056, and having a Shore Hardness of 40, measured according to ISO868;

### Comparative Examples 1-6 and Examples 1-3

In each of the Comparative Examples 1-6 and Examples 1-3, an appropriate amount of PTT or PBT and copolyether ester-1 (the weight ratios of each components are listed in Table 1) were dried, pre-blended and melt-blended through a ZSK26 twin-screw extruder (purchased from German company Coperion WP) with a temperature set at 230-255° C., extruding speed set at 350 rpm, and the throughput set at 25 kg/hr, to obtain the desired compositions.

In addition, the compositions obtained from Comparative Examples 1-6 and Examples 1-3 were injected into dumbbell-shaped test specimens. Their flexural modulus were measured according to ISO178:2001; their tensile strengths, tensile modulus and elongation at break % were measured respectively according to ISO527-2:1993.

Test results are listed in Table 1.

TABLE 1

| | | | | Physical Properties | | | | | |
|---|---|---|---|---|---|---|---|---|---|
| | Formula | | | | Flexural | | | Tensile | |
| | | Copolyether | | Flexural | Modulus | Tensile | Tensile | Modulus | Elongation |
| | PTT | Ester-1 | PBT | Modulus | Change | Stress | Modulus | Change | at Break |
| Example No. | (wt. %) | (wt. %) | (wt. %) | (MPa) | Rate | (MPa) | (MPa) | Rate | (%) |
| Comparative | 100 | — | — | 2689 | n/a³ | 56 | 2830 | n/a³ | 11.3 |
| Example 1 | | | | | | | | | |
| Example 1 | 90 | 10 | — | 2422 | −9%¹ | 56.4 | 2537 | −10%¹ | 14.2 |
| Example 2 | 80 | 20 | — | 2228 | −17%¹ | 54.27 | 2227 | −23%¹ | 8.2 |
| Example 3 | 70 | 30 | — | 1945 | −28%¹ | 48.25 | 1943.7 | −31%¹ | 11.58 |
| Comparative | — | — | 100 | 2524 | n/a³ | 21.66 | 2618 | n/a³ | 58.49 |
| Example 2 | | | | | | | | | |
| Comparative | — | 10 | 90 | 2254 | −11%² | 16.7 | 2415.7 | −8%² | 59.45 |
| Example 3 | | | | | | | | | |
| Comparative | — | 20 | 80 | 1990 | −21%² | 15 | 2111.4 | −19%² | 105.8 |
| Example 4 | | | | | | | | | |
| Comparative | — | 30 | 70 | 1711 | −32%² | 27.31 | 1894.45 | −28%² | 184.03 |
| Example 5 | | | | | | | | | |
| Comparative | — | 100 | — | 297.4 | n/a³ | 40 | n/a³ | n/a³ | 549 |
| Example 6 | | | | | | | | | |

Note 1:
This change rate is the change in percentage of the flexural modulus or tensile modulus relative to Comparative Example 1;
Note 2:
This change rate is the change in percentage of flexural modulus or tensile modulus relative to Comparative Example 2
Note 3:
n/a means not applicable or not tested

Table 1 shows that when copolyether ester-1 and PBT are melt-blended (Comparative Examples 3-5), the flexural modulus and tensile modulus decreased with the increase of the amount of copolyether ester-1, but the elongation at break % s also significantly increased correspondingly. On the contrary, when copolyether ester-1 and PTT are melt-blended (Examples 1-3), the flexural modulus and tensile modulus decreased and the elongation at break % didn't increase correspondingly but remained basically the same or slightly increased (Examples 1 and 3), or even decreased (Example 2).

### Comparative Examples 7-10

In each of the Comparative Examples 7-10, an appropriate amount of PTT and copolyether ester-2 (the weight ratios of each components are listed in Table 2) were dried, pre-blended and melt-blended through a ZSK26 twin-screw extruder (purchased from German company Coperion WP) with the temperature set at 230-255° C., extruding speed set at 350 rpm and throughput set at 25 kg/hr, to obtain the desired compositions.

TABLE 2

| | Formula | |
|---|---|---|
| | PTT | Copolyether Ester-2 |
| Example No. | (wt. %) | (wt. %) |
| Comparative Example 7 | 85 | 15 |
| Comparative Example 8 | 83 | 17 |
| Comparative Example 9 | 80 | 20 |
| Comparative Example 10 | 70 | 30 |

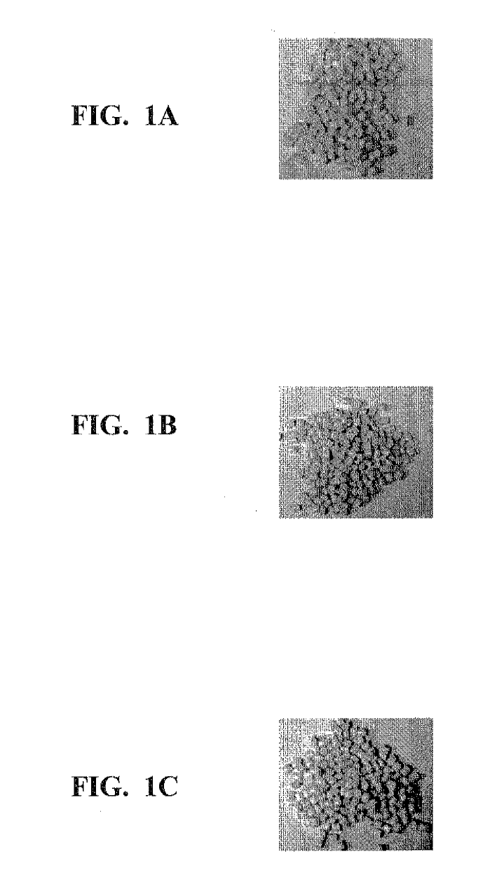

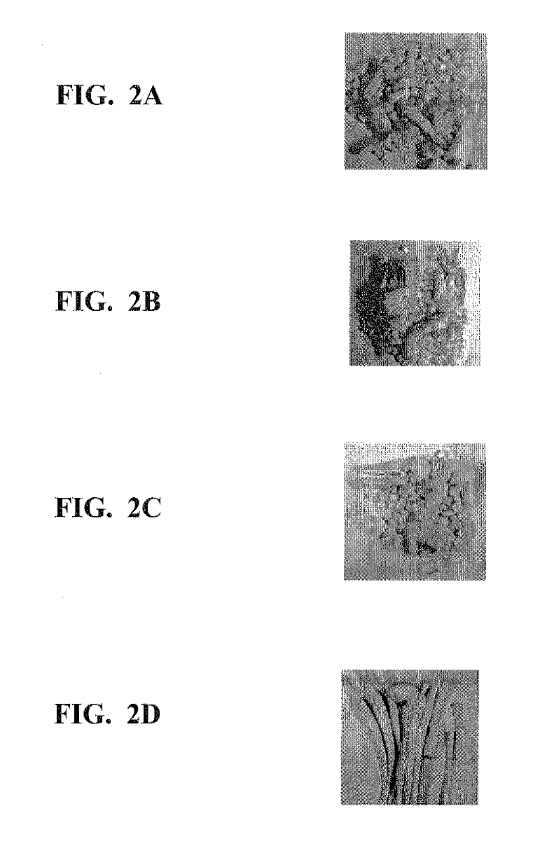

The extrusion processability and compounding compatibility of the compositions in Examples 1-3 and Comparative Examples 7-10 were examined and photographed with a digital camera respectively. The results are shown in FIGS. 1A, 1B and 1C (corresponding to Examples 1-3 respectively) and in FIGS. 2A, 2B, 2C and 2D (corresponding to Comparative Examples 7-10).

For the compositions of PTT and copolyether ester-1 obtained from Examples 1-3, the melt-blending process went very well, having good processability, and all of the compositions can be cooled down by water after extrusion and cut successfully into regular pellets shown in FIGS. 1A, 1B and 1C.

However, for the compositions of PTT and copolyether ester-2 obtained from Comparative Examples 7-10, obvious extrudate line breaking and incompatibility were observed during the melt-blending process. And the compatibility became worse and worse with the increase of the amount of the copolyether ester-2 from 15 wt. %, to 17 wt. %, to 20 wt. % to 30 wt. %. As a result, each composition became difficult to form threads and difficult to be cut into pellets. The irregular materials formed due to the failure of extrusion are shown in FIGS. 2A, 2B, 2C and 2D.

The detailed examples above described are given for the purpose of elucidating the invention. It should not be understood as limiting the scope of the invention in any way. On the contrary, it should be clearly understood that, after reading the specification, a person skilled in the art can carry out other technical solutions or modifications without departing from the spirits of the invention.

What is claimed is:

1. A monofilament bristle made of modified polytrimethylene terephthalate composition, wherein, based on the total weight of the modified polytrimethylene terephthalate composition, the modified polytrimethylene terephthalate composition comprises:
(a) 65-95 wt. % of at least a polytrimethylene terephthalate, and
(b) 5-35 wt. % of at least a copolyether-ester having a Shore Hardness of 55 or higher measured according to ISO868,
and the modified polytrimethylene terephthalate composition has a flexural modulus of 2500 MPa or lower measured according to ISO178:2001, a tensile modulus of 2600 MPa or lower, and an elongation at break % of 20% or lower, measured respectively according to ISO527-2:1993.

2. The monofilament bristle according to claim 1, wherein the modified polytrimethylene terephthalate composition is a single phase composition formed by at least a polytrimethylene terephthalate and at least a copolyether-ester.

3. The monofilament bristle according to claim 1, wherein, based on the total weight of the modified polytrimethylene terephthalate composition, the at least a polytrimethylene terephthalate and at least a copolyether-ester are present in an amount of 70-90 wt. % and 10-30 wt. % respectively, or preferably 75-85 wt. % and 15-25 wt. % respectively.

4. The monofilament bristle according to claim 1, wherein the modified polytrimethylene terephthalate composition has a flexural modulus of 1800-2500 MPa, a tensile modulus of 1800-2600 MPa, and an elongation at break % of 5-15%.

5. The monofilament bristle according to claim 4, wherein the modified polytrimethylene terephthalate composition has a flexural modulus of 2100-2300 MPa, a tensile modulus of 2200-2300 MPa, and an elongation at break % of 8-15%.

6. The monofilament bristle according to claim 1 wherein the at least a copolyether-ester has a Shore Hardness of 55-82, or preferably 60-70, measured according to ISO868.

7. The monofilament bristle according to claim 1 wherein the at least a polytrimethylene terephthalate has an intrinsic viscosity of 0.8-1.7 dl/g, or preferably 0.9-1.4 dl/g.

8. The monofilament bristle according to claim 1, wherein, the copolyether-ester comprises a plurality of repeating long-chain ester units and repeating short chain ester units linked head to tail through ester bond, the long chain ester unit is represented by Formula (I): 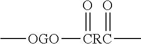
and the short chain ester unit is represented by Formula (II): 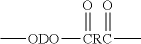
wherein:
G is a residual divalent group by the removal of the ending hydroxyl group from poly (methylene ether) diol having a number average molecular weight of 400-6000;
R is a residual divalent group by the removal of the carboxylic group from dicarboxylic acids having a number average molecular weight of 300 or less;
D is a residual divalent group by the removal of the hydroxyl group from diol having a number average molecular weight of 250 or less;
and wherein the copolyether-ester comprises 1-60 wt. % the repeating long chain ester units and 40-99 wt. % of the repeating short chain units.

9. The monofilament bristle according to claim 8, wherein, the copolyether-ester comprises 10-50 wt. % of the repeating long chain ester units and 50-90 wt. % of the repeating short chain units.

10. The brush comprising the monofilament bristle according to claim 1.

11. The brush according to claim 10, wherein the brush is selected from a toothbrush, paint brush, cosmetic brush or industrial brush.
